(19) United States
(12) Patent Application Publication
(10) Pub. No.: US 2026/0090688 A1
(43) Pub. Date: Apr. 2, 2026

(54) ROBOT AND OPERATION METHOD THEREOF

(71) Applicant: Samsung Electronics Co., Ltd., Suwon-si (KR)

(72) Inventors: Sohee LIM, Suwon-si (KR); Dongeui Shin, Suwon-si (KR); Yeongrok Lee, Suwon-si (KR); Boseok Moon, Suwon-si (KR)

(73) Assignee: Samsung Electronics Co., Ltd., Suwon-si (KR)

(21) Appl. No.: 19/304,090

(22) Filed: Aug. 19, 2025

Related U.S. Application Data
(63) Continuation of application No. PCT/KR2025/009670, filed on Jul. 4, 2025.

(30) Foreign Application Priority Data
Sep. 27, 2024 (KR) 10-2024-0131842

(51) Int. Cl. A47L 9/28; G06V 10/147; G06V 10/40

(52) U.S. Cl. CPC A47L 9/2805; G06V 10/147; G06V 10/40; A47L 2201/04; A47L 2201/06

(57) ABSTRACT

A robot includes a first camera sensor arranged at a first capturing angle to capture a driving space of the robot, a mirror arranged at a first arrangement angle at a first location of the robot; at least one processor including a processing circuit. The robot acquires, using the first camera sensor, a first image corresponding to a first area within the driving space. The robot identifies, based on the first image, a second image, corresponding to a second capturing angle, in which a second area within the driving space is reflected by the mirror. The robot identifies a third image of the second area captured at the first capturing angle based on the acquired first image, and identifies an object of a liquid type within the second area based on the second image corresponding to the second capturing angle and the third image corresponding to the first capturing angle.

### CROSS-REFERENCE TO RELATED APPLICATION(S)

This application is a continuation of International Application No. PCT/KR2025/009670, filed on Jul. 4, 2025, in the Korean Intellectual Property Receiving Office, which claims priority to Korean Patent Application No. 10-2024-0131842, filed on Sep. 27, 2024, in the Korean Intellectual Property Office, the disclosures of which are incorporated by reference herein in their entireties.

### BACKGROUND

### 1. Field

The disclosure relates to a robot and an operation method thereof, and more particularly, to a robot that drives through a space and an operation method thereof.

### 2. Description of Related Art

With the development of electronic technology, various types of electronic devices are being developed. Technology development for robots that provide services to users, and the like, has been actively developed. In the case of a robot that drives through a specific space to provide a service to a user, there may be a situation in which the robot passes through or removes an object existing within a driving path. The robot may drive through a specific space efficiently by accurately identifying a location and type of the object.

### SUMMARY

According to an aspect of the disclosure, there is provided a robot including: a first camera sensor arranged at a first capturing angle to capture a driving space of the robot; a mirror arranged at a first arrangement angle at a first location of the robot; at least one processor including a processing circuit; and a memory storing instructions, and including one or more storage media, wherein the instructions, when individually or collectively executed by the at least one processor, cause the robot to: acquire, using the first camera sensor, a first image corresponding to a first area within the driving space; identify, based on the first image, a second image, corresponding to a second capturing angle, in which a second area within the driving space is reflected by the mirror; identify a third image of the second area captured at the first capturing angle based on the acquired first image; and identify an object of a liquid type within the second area based on the second image corresponding to the second capturing angle and the third image corresponding to the first capturing angle.

The first capturing angle may be an angle at which the first camera sensor is tilted with respect to a line perpendicular to a ground, and wherein the second capturing angle may be a capturing angle corresponding to a reflected image that is reflected by the mirror arranged at the first arrangement angle.

The first area includes the second area, and wherein the instructions, when individually or collectively executed by the at least one processor, may cause the robot to: calibrate the second image; identify the third image corresponding to an area matching the second image among the first image corresponding to the first area; and provide the calibrated second image and the identified third image to a first trained neural network model to identify whether the object of the liquid type exists within the second area.

The instructions, when individually or collectively executed by the at least one processor, may cause the robot to: provide the calibrated second image and the identified third image to a trained second neural network model to identify whether the object of the liquid type exists within the second area; provide the calibrated second image and the identified third image to a trained third neural network model to identify location information of the object of the liquid type based on identifying that the object of the liquid type exists within the second area; and perform at least one of avoidance driving for the object of the liquid type or a removal operation for the object of the liquid type based on the identified location information.

The instructions, when individually or collectively executed by the at least one processor, may cause the robot to: provide the calibrated second image and the identified third image to a trained fourth neural network model to identify location information of another object of a preset type existing within the second area; and perform avoidance driving for the another object of the preset type based on the identified location information.

The first location may be included in an area corresponding to a field of view of the first camera sensor, and may be a relatively higher location than the first camera sensor.

The robot may further include: a second camera sensor arranged at a third capturing angle to capture the first area, wherein the instructions, when individually or collectively executed by the at least one processor, may cause the robot to: acquire, using the second camera sensor, a fourth image corresponding to the first area within the driving space; identify a fifth image of the second area reflected by the mirror based on the fourth image; identify a sixth image corresponding to the second area based on the acquired fourth image; and identify the object of the liquid type within the second area based on the identified fifth image and the identified sixth image.

The first camera sensor may be implemented as a red, green, and blue (RGB) camera, and wherein the second camera sensor may be implemented as a stereo camera including camera sensors corresponding to a left eye and a right eye, respectively, and wherein the instructions, when individually or collectively executed by the at least one processor, may cause the robot to identify the object of the liquid type within the driving space based on each of the identified second image, the identified third image, the identified fifth image, and the identified sixth image.

The second area further may include a third area that is a distance greater than a preset distance from the robot, and wherein the instructions, when individually or collectively executed by the at least one processor, may cause the robot to: identify a seventh image corresponding to the third area among the second image; and identify the object of the liquid type within the third area based on the identified seventh image and the identified third image.

The instructions, when individually or collectively executed by the at least one processor, may cause the robot to: identify a driving path based on a location of the third area based on identifying that the object exists in the third area; and identify location information of the object of the liquid type based on identifying that the robot is less than the preset distance from the third area while driving along the identified driving path; and perform at least one of avoidance driving for the object of the liquid type or a removal operation for the object of the liquid type based on the identified location information.

The mirror may be arranged at a second arrangement angle different from the first arrangement angle, and wherein the instructions, when individually or collectively executed by the at least one processor, may cause the robot to: identify, using the first camera sensor, the second image of the second area within the driving space reflected by the mirror arranged at the second arrangement angle; identify an eighth image corresponding to a fourth area, which is not included in the first area, in the second area, based on the second image; and identify whether another object exists within the fourth area based on the eighth image.

The fourth area may be a blind area that is out of a field of view of the first camera sensor, and wherein the instructions, when individually or collectively executed by the at least one processor, may cause the robot to perform a rotation operation of the robot based on whether the object is identified within the fourth area.

The instructions, when individually or collectively executed by the at least one processor, may cause the robot to: compare a location of a first object within the second image and a location of a second object within the third image based on the first object of the liquid type being identified within the second image and the second object of the liquid type being identified within the third image; and identify whether the first object and the second object are a same object based on a result of the comparison.

According to an aspect of the disclosure, there is provided an operation method of a robot, including: acquiring, using a first camera sensor arranged at a first capturing angle, a first image corresponding to a first area within a driving space of the robot; identifying, based on the first image, a second image, corresponding to a second capturing angle, in which a second area within the driving space is reflected by a mirror located at a first arrangement angle at a first location of the robot; identifying a third image of the second area captured at the first capturing angle based on the acquired first image; and identifying an object of a liquid type within the second area based on the second image corresponding to the second capturing angle and the third image corresponding to the first capturing angle.

According to an aspect of the disclosure, there is provided a non-transitory computer-readable storage medium storing instructions, wherein the instructions, when executed by at least one processor of a robot, cause the robot to: acquire, using a first camera sensor arranged at a first capturing angle, a first image corresponding to a first area within a driving space; identify, based on the first image, a second image, corresponding to a second capturing angle, in which a second area within the driving space is reflected by a mirror located at a first arrangement angle at a first location of the robot; identify a third image of the second area captured at the first capturing angle based on the acquired first image; and identify an object of a liquid type within the second area based on the second image corresponding to the second capturing angle and the third image corresponding to the first capturing angle.

### BRIEF DESCRIPTION OF THE DRAWINGS

The above and other aspects, features, and/or advantages of embodiments of the disclosure will be more apparent from the following description taken in conjunction with the accompanying drawings, in which:

FIG. 1A is a block diagram illustrating a configuration of a robot, according to an embodiment;

FIG. 1B is a diagram describing an operation method of a robot, according to an embodiment;

FIG. 1C is a diagram for describing the operation method of a robot, according to an embodiment;

FIG. 1D is a diagram for describing the operation method of a robot, according to an embodiment;

FIG. 1E is a diagram for describing the operation method of a robot, according to an embodiment;

FIG. 2 is a flowchart for describing the operation method of a robot, according to an embodiment;

FIG. 3 is a flowchart describing a method for identifying presence of an object, according to an embodiment;

FIG. 4 is a flowchart for describing an operation of a robot related to an object, according to an embodiment;

FIG. 5 is a flowchart for describing a method for performing avoidance driving for an object, according to an embodiment;

FIG. 6A is a flowchart for describing a method for identifying whether an object exists, according to an embodiment;

FIG. 6B is a diagram for describing the method for identifying whether an object exists, according to an embodiment;

FIG. 7A is a flowchart for describing a method for identifying whether an object exists, according to an embodiment;

FIG. 7B is a diagram for describing the method for identifying whether an object exists, according to an embodiment;

FIG. 7C is a diagram for describing the method for identifying whether an object exists, according to an embodiment;

FIG. 8 is a flowchart for describing an operation of a robot related to an object, according to an embodiment;

FIG. 9A is a flowchart for describing a method for identifying whether an object exists, according to an embodiment;

FIG. 9B is a diagram for describing the method for identifying whether an object exists, according to an embodiment;

FIG. 10A is a diagram for describing a role of a mirror, according to an embodiment;

FIG. 10B is a diagram for describing a role of a mirror, according to an embodiment; and

FIG. 11 is a block diagram illustrating a detailed configuration of a robot, according to an embodiment.

### DETAILED DESCRIPTION

Below, the disclosure will be described in detail with reference to the accompanying drawings.

After terms used in the specification are schematically described, the disclosure will be described in detail.

General terms that are currently widely used were selected as terms used in embodiments of the disclosure in consideration of functions in the disclosure, but may be changed according to the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the disclosure. Therefore, the terms used in embodiments of the disclosure are to be defined on the basis of the meaning of the terms and the contents throughout the disclosure rather than simple names of the terms.

In the specification, an expression “have”, “may have”, “include”, “may include”, or the like, indicates existence of a corresponding feature (e.g., a numerical value, a function, an operation, a component such as a part, or the like), and does not exclude existence of an additional feature.

An expression “at least one of A and/or B” is to be understood to represent “A” or “B” or “any one of A and B”.

Expressions “first,” “second,” “1st” or “2nd” or the like, used in the present disclosure may indicate various components regardless of a sequence and/or importance of the components, will be used only in order to distinguish one component from the other components, and do not limit the corresponding components.

When it is mentioned that any component (for example, a first component) is (operatively or communicatively) coupled with/to or is connected to another component (for example, a second component), it is to be understood that any component is directly coupled to another component or may be coupled to another component through the other component (for example, a third component).

Singular forms include plural forms unless the context clearly indicates otherwise. It should be understood that terms “include” or “formed of” used in the specification specify the presence of features, numerals, steps, operations, components, parts, or combinations thereof mentioned in the specification, but do not preclude the presence or addition of one or more other features, numerals, steps, operations, components, parts, or combinations thereof.

In the disclosure, a “module” or a “˜er/or” may perform at least one function or operation, and be implemented as hardware or software or be implemented as a combination of hardware and software. In addition, a plurality of “modules” or a plurality of ‘portions’ may be integrated in at least one module and be implemented by at least one processor except for a “module” or a “portion” that needs to be implemented by specific hardware.

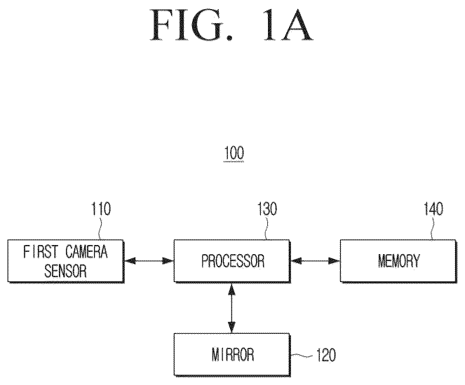

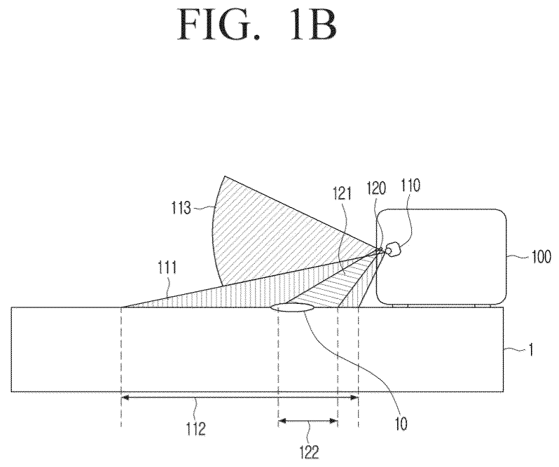

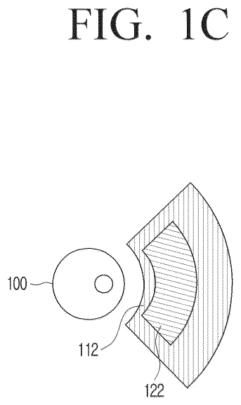

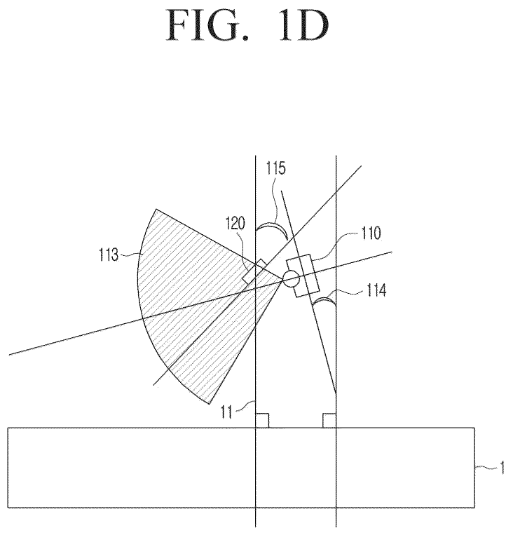

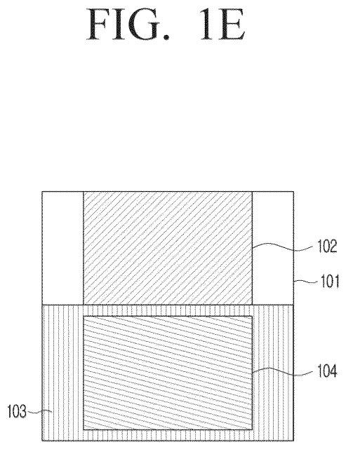

FIGS. 1A to 1E are diagrams for describing the operation of a robot 100 according to an embodiment of the present disclosure.

Referring to FIGS. 1A to 1E, according to an embodiment, the robot 100 may be implemented as a drivable robot 100 in a driving space. For example, the robot 100 may include a first camera sensor 110, a mirror 120, at least one processor 130, and a memory 140.

According to an embodiment, the robot 100 may drive in the driving space to reach a destination. The robot 100 may be a robot that moves to a specific location and provides a service to a user. For example, the robot may be a different type of driving robot including, but not limited to, a drone and a wheel robot.

According to an embodiment, the first camera sensor 110 may be arranged within the robot 100 at a first capturing angle 114. For example, the first camera sensor 110 may be implemented as a red, green, and blue (RGB) camera. Alternatively, according to one example, the first camera sensor 110 may be implemented as a stereo camera. For example, the stereo camera may include a camera corresponding to a left eye of a person and a camera corresponding to a right eye of a person, respectively. For example, when the first camera sensor 110 is implemented as a stereo camera, the first camera sensor 110 may acquire three-dimensional (3 Dimensional) image information including disparity information through images obtained from a plurality of cameras (e.g., a camera corresponding to a left eye and a camera corresponding to a right eye).

Alternatively, according to one example, the first camera sensor 110 may be a stereo camera implemented as an IR camera. However, the present disclosure is not limited thereto, and the first camera sensor 110 may of course be implemented as a camera of a different type. For example, the first camera sensor 110 may be arranged at a position corresponding to a preset height from the ground.

For example, the first capturing angle 114 may be an angle 114 at which the first camera sensor 110 is tilted based on a line 11 perpendicular to the ground 1. For example, the angle 114 at which the first camera sensor 110 is tilted may be an angle between a line perpendicular to the ground 1 and a line perpendicular to a capturing direction of the first camera sensor 110.

According to an embodiment, the first camera sensor 110 may capture a driving space of the robot 100. For example, the first camera sensor 110 may capture the driving space of the robot 100 within a capturing range within a preset field of view (FOV) 113. For example, the driving space may include a first area 112. For example, an image 101 corresponding to the driving space acquired (or captured) through the first camera sensor 110 may include an image 103 corresponding to the first area 112 within the driving space of the robot 100.

For example, the first area 112 may be a floor area located within a preset distance from the robot 100. For example, the first area 112 may be an area in the driving space corresponding to the capturing range 111 between the capturing direction and the field of view 113 corresponding to the first camera sensor 110. For example, as illustrated in FIG. 1C, the first area 112 may be an area formed based on the field of view 113 corresponding to the first camera sensor 110, and according to one example, the first area 112 may be an area within a preset range of distances from the robot 100. For example, the first area 112 may be at least a portion of an area that may be captured through the first camera sensor 110.

According to an embodiment, the mirror 120 may be arranged at a first arrangement angle 115 at a first location of the robot 100. For example, the first location may be included in an area corresponding to the field of view 113 of the first camera sensor 110 and may be a relatively higher location than the first camera sensor 110. For example, the area corresponding to the field of view 113 may be an area located within the field of view 113 of the first camera sensor 110 and included in an image 101 acquired through the first camera sensor 110. For example, the mirror 120 may be included in the area corresponding to the field of view 113, but is not limited thereto, and as illustrated in FIG. 1D, a portion of the mirror 120 may be included in the area corresponding to the field of view 113. For example, the mirror 120 may be arranged at a relatively higher location than the first camera sensor 110 within the robot 100.

For example, the first arrangement angle 115 may be an angle between the line 11 perpendicular to the ground and a line parallel to a reflective surface of the mirror 120. For example, the image 101 acquired through the first camera sensor 110 may include an image 102 of a specific area (or, a second area 122) in the driving space reflected through the mirror 120 arranged at the first arrangement angle 115. For example, different types of images may be acquired depending on the arrangement angle of the mirror 120.

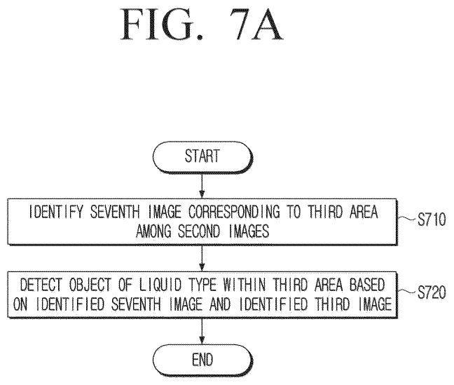

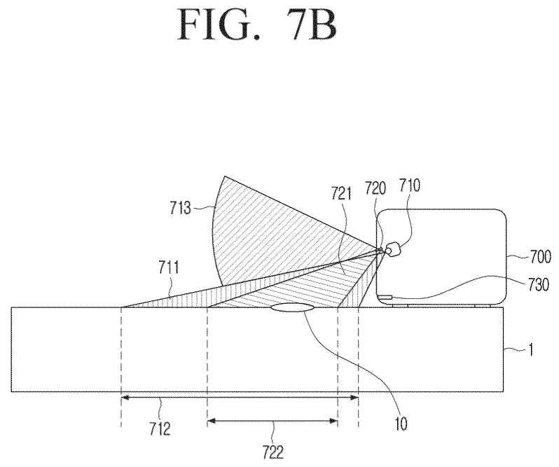

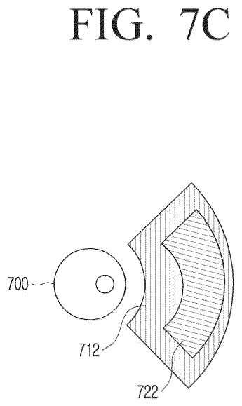

For example, as the arrangement angle of the mirror 120 increases, the range of the area reflected through the mirror 120 may become relatively wider. For example, when the arrangement angle of the mirror 120 is greater than or equal to a preset angle (or, when the range of the area reflected through the mirror 120 is relatively wide), the robot 100 may divide the area reflected through the mirror 120 into multiple areas and detect (e.g., identify) an object 10 of a liquid type based on the images corresponding to each of the multiple divided areas. This will be described in detail with reference to FIGS. 7A and 7B.

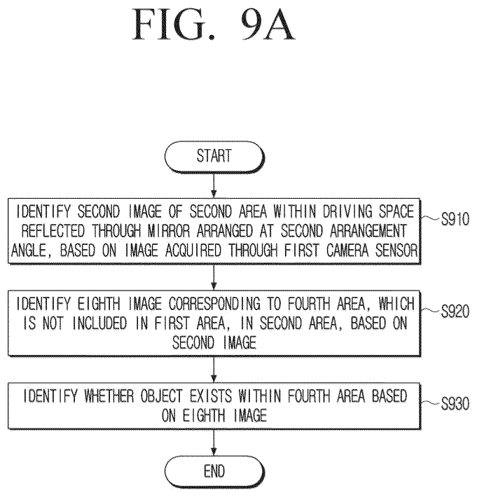

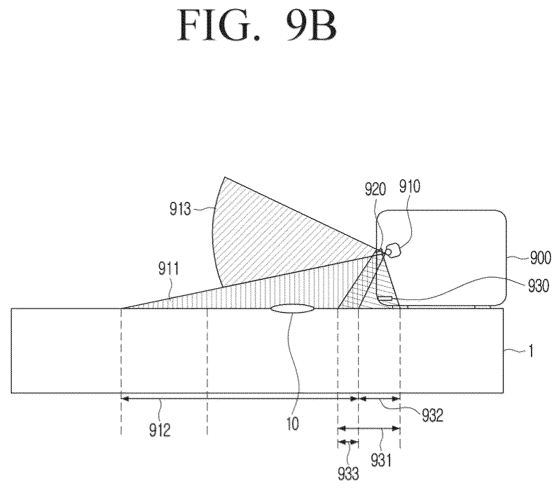

Alternatively, for example, as the arrangement angle of the mirror 120 decreases, the range of the area reflected through the mirror 120 may become relatively narrower. For example, when the arrangement angle of the mirror 120 is less than a preset angle, the area reflected through the mirror 120 may include a blind area that may not be captured through the first camera sensor 110 as an area other than the first area 112. For example, the robot 100 may detect the object 10 existing in the blind area based on the image 102 of the area reflected through the mirror 120. This will be described in detail with reference to FIGS. 9A and 9B.

At least one processor 130 (hereinafter, “processor”) is electrically connected to the first camera sensor 110, the mirror 120, and the memory 140 to control the overall operation of the robot 100. The processor 130 may be composed of one or more processors. Specifically, the processor 130 may perform an operation of the robot 100 according to various embodiments of the present disclosure by executing at least one instruction stored in the memory 140.

According to an embodiment, the processor 130 may be implemented by a digital signal processor (DSP), a microprocessor, a graphics processing unit (GPU), an artificial intelligence (AI) processor, a neural processing unit (NPU), or a time controller (TCON) that processes a digital image signal. However, the processor 130 is not limited thereto, and may include one or more of a central processing unit (CPU), a micro controller unit (MCU), a micro processing unit (MPU), a controller, an application processor (AP), a communication processor (CP), and an ARM processor, or may be defined by these terms. In addition, the processor 130 may be implemented by a system-on-chip (SoC) or a large scale integration (LSI) in which a processing algorithm is embedded, or may be implemented in the form of an application specific integrated circuit (ASIC) and a field programmable gate array (FPGA).

The memory 140 may store data for various embodiments. The memory 140 may be implemented in a form of a memory embedded in the robot 100 or a form of a memory detachable from the robot 100, depending on a data storage purpose. For example, data for driving the robot 100 may be stored in the memory embedded in the robot 100, and data for an extension function of the robot 100 may be stored in the memory detachable from the robot 100.

The memory embedded in the robot 100 may be implemented in at least one of, for example, a volatile memory (for example, a dynamic random access memory (DRAM), a static RAM (SRAM), a synchronous dynamic RAM (SDRAM), or the like), a non-volatile memory (for example, a one time programmable read only memory (OTPROM), a programmable ROM (PROM), an erasable and programmable ROM (EPROM), an electrically erasable and programmable ROM (EEPROM), a mask ROM, a flash ROM, a flash memory (for example, a NAND flash, a NOR flash, or the like), a hard drive, and a solid state drive (SSD)). In addition, the memory detachable from the robot 100 may be implemented in the form of the memory card (e.g., compact flash (CF), secure digital (SD), micro secure digital (Micro-SD), mini secure digital (Mini-SD), extreme digital (xD), multi-media card (MMC), etc.), external memory (e.g., USB memory) connectable to a USB port, and the like.

According to an embodiment, the processor 130 may acquire an image through the first camera sensor 110. For example, the image acquired through the first camera sensor 110 may be the image 101 corresponding to the driving space of the robot 100. For example, the processor 130 may acquire the first image 103 corresponding to the first area 112 through the first camera sensor 110. For example, the processor 130 may acquire the first image 103 corresponding to the first area 112 among the images 101 corresponding to the driving space. For example, the processor 130 may acquire the first image 103 corresponding to the first area 112 within the image 101 corresponding to the driving space by using coordinate information corresponding to an area within a preset distance from the robot 100. For example, the coordinate information of the image 103 corresponding to the first area 112 among the images 101 corresponding to the driving space acquired through the first camera sensor 110 may be stored in the memory 140. The processor 130 may identify the first image 103 from the image 101 corresponding to the driving space based on the information stored in the memory 140.

For example, when the first camera sensor 110 is implemented as an RGB camera, the image 101 corresponding to the driving space may be an image having RGB color values for each pixel included in the image. Alternatively, according to one example, when the first camera sensor 110 is implemented as an IR camera, the image 101 corresponding to the driving space may be a thermal image.

For example, the processor 130 may identify an image corresponding to an area in a specific area of the driving space reflected through the mirror 120. For example, the processor 130 may identify a second image 102 corresponding to a second capturing angle, which is reflected through the mirror 120 in a second area 122 within the driving space, based on the image 101 acquired through the first camera sensor 110.

For example, the second area 122 may be an area reflected through the mirror 120 based on the first camera sensor 110. For example, the second area 122 may be an area in the driving space corresponding to a reflection range 121 of light reflected through a mirror among light incident on the first camera sensor 110. For example, the second image 102 corresponding to the second area 122 may be included in the image 101 acquired through the first camera sensor 110.

For example, the processor 130 may identify the second image 102 reflected through the mirror 120 in the second area 122 using the coordinate information corresponding to the mirror 120 in the image 101 corresponding to the driving space. For example, the memory 140 may store the coordinate information of the image corresponding to the mirror among the images 101 corresponding to the driving space acquired through the first camera sensor 110. The processor 130 may identify the second image 102 from the image 101 corresponding to the driving space based on the information stored in the memory 140.

For example, the second image 102 reflected through the mirror 120 arranged at the first arrangement angle 115 may be an image corresponding to a capturing angle (or, a second capturing angle) different from the first capturing angle 114 corresponding to the first camera sensor 110. For example, the second image 102 may correspond to an image of the second area 122 captured at the second capturing angle.

According to an embodiment, the processor 130 may identify a third image 104 of the second area 122 captured at the first capturing angle 114. For example, the processor 130 may identify the third image 104 corresponding to the second area 122 among the first images 103 corresponding to the first area 112 captured at the first capturing angle 114. For example, the third image 104 corresponding to the second area 122 may be an image captured at the first capturing angle 114. For example, the processor 130 may identify the third image 104 using the coordinate information corresponding to the second area 122 in the first image 103 acquired through the first camera sensor 110. For example, the memory 140 may store the coordinate information of the image corresponding to the second area in the first image 103 acquired through the first camera sensor 110. The processor 130 may identify the third image 104 from the first image 103 based on the information stored in the memory 140.

According to an embodiment, the processor 130 may detect the object 10 existing in the second area 122. For example, the processor 130 may detect the object 10 of the liquid type in the second area 122 based on the second image 102 corresponding to the second capturing angle and the third image 104 corresponding to the first capturing angle 114.

For example, the object 10 may be the object of liquid type, but is not limited thereto, and may be an object of a different type (for example, an object type, etc.). For example, the operation of detecting the object 10 may include at least one of an operation of identifying whether the object 10 exists and an operation of identifying the exact location of the object 10 when the object 10 is identified.

For example, the processor 130 may detect the object 10 of the liquid type existing in the second area 122 using images of different capturing angles corresponding to the second area 122. For example, the processor 130 may input (e.g., provide) the second image 102 and the third image 104 into a trained neural network model to classify whether the object 10 of the liquid type exists in the second area 122. For example, the trained neural network model may be a model trained to classify the image based on whether the object 10 of the liquid type exists in the input image.

For example, the processor 130 may input each of the second image 102 and the third image 104 corresponding to the second area 122 to the trained neural network model. For example, the processor 130 may input the second image 102 to the trained neural network model to identify whether the second image 102 includes the object 10 of the liquid type. Alternatively, for example, the processor 130 may input the third image 104 into the trained neural network model to identify whether the third image 104 includes the object 10 of the liquid type.

For example, when the processor 130 identifies that the object 10 exists in the second area 122 based on at least one of the second image 102 and the third image 104, the processor 130 may identify the location information of the object 10 of the liquid type based on at least one of the second image 102 and the third image 104. For example, the location information may be information about the location of the object 10 of the liquid type within the driving space. For example, the processor 130 may identify the information about the location of the object 10 of the liquid type using the trained neural network model. For example, when the object 10 exists in the second area 122, the processor may input at least one of the second image 102 and the third image 104 to the trained neural network model to identify the location information of the object 10 of the liquid type existing in the second area 122.

For example, the trained neural network model for identifying the presence or absence of the object 10 of the liquid type in the second area 122 and the trained neural network model for identifying the location of the object 10 of the liquid type existing in the second area may be implemented as different models, but are not limited thereto, and it is to be understood that the above-described neural network model may be implemented as a single neural network model. For example, the trained neural network model of the present disclosure may be stored in the memory 140, but is not limited thereto, and the trained neural network model may be stored in an external device (e.g., a server).

According to an embodiment, the processor 130 may perform avoidance driving for the object 10 of the liquid type or perform a removal operation for the object 10 of the liquid type based on the location information of the identified object of liquid type 10. For example, the processor 130 may identify a driving path for avoiding the object 10 based on the location information of the object 10 of the liquid type, and drive in the driving space based on the identified driving path. Alternatively, for example, the processor 130 may perform a driving operation to move to the location of the object 10 based on the location information of the object 10 of the liquid type, and then perform the removal operation for the object 10.

In the case of the object 10 of the liquid type, the reflectivity of the surface of the liquid may vary depending on the capturing angle, and when the object 10 of the liquid type is captured at a specific capturing angle, there may be the case where the object 10 of the liquid type is not identified. According to the above-described example, the robot 100 of the present disclosure may detect liquid through images corresponding to multiple capturing angles for a specific area (e.g., the second area 122) in the driving space, and thus may detect liquid with a high detection rate.

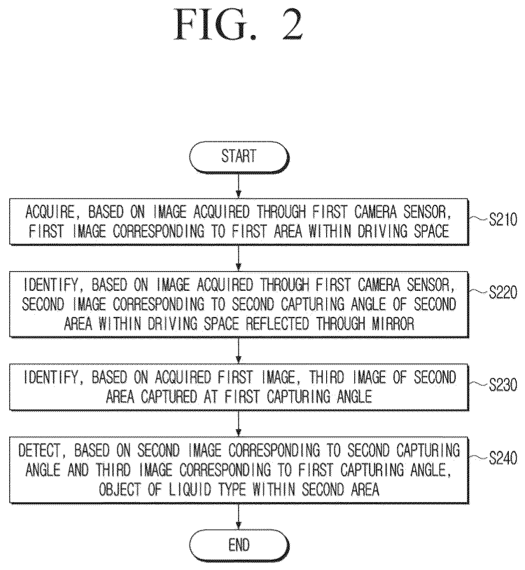

FIG. 2 is a flowchart for describing the operation method of a robot according to an embodiment.

Referring to FIG. 2, according to an embodiment, the operation method may include an operation (S210) of acquiring the first image (e.g., the first image 103 of FIG. 1E) corresponding to the first area (e.g., the first area 112 of FIG. 1B) in the driving space based on the image (e.g., the image 101 corresponding to the driving space of FIG. 1E) acquired through the first camera sensor (e.g., the first camera sensor 110 of FIG. 1A). For example, a robot (e.g., the robot 100 of FIG. 1A) may acquire the first image corresponding to the first area within the driving space based on the acquired image when the image is acquired through the first camera sensor.

According to an embodiment, the operation method may include an operation (S220) of identifying the second image (e.g., the second image 102 of FIG. 1E) corresponding to the second capturing angle (e.g., the second capturing angle of FIG. 1D) of a second area (e.g., the second area 122 of FIG. 1B) within the driving space reflected through the mirror (e.g., the mirror 102 of FIG. 1A) based on the image acquired through the first camera sensor. For example, the robot may identify the second image corresponding to the second capturing angle of the second area within the driving space reflected through the mirror based on the image acquired through the first camera sensor.

According to an embodiment, the operation method may include an operation (S230) of identifying the third image (e.g., the third image 104 of FIG. 1E) of the second area captured at the first capturing angle (e.g., the first capturing angle 114 of FIG. 1D) based on the acquired first image. For example, the robot may identify the third image of the second area captured at the first capturing angle when the first image is acquired.

According to an embodiment, the operation method may include an operation (S240) of detecting the object of the liquid type (e.g., the object 10 of FIG. 1B) within the second area based on the second image corresponding to the second capturing angle and the third image corresponding to the first capturing angle. For example, the robot may detect the object of the liquid type within the second area based on the second image corresponding to the second capturing angle and the third image corresponding to the first capturing angle.

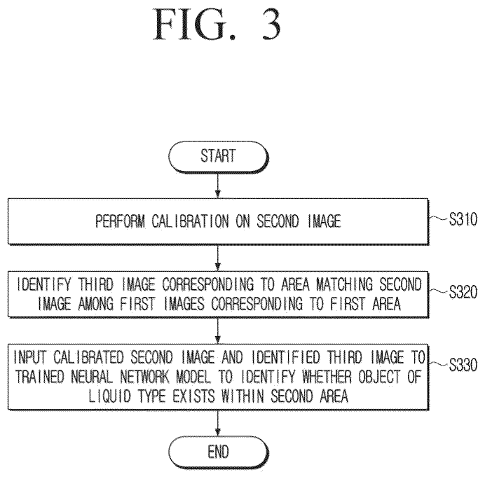

FIG. 3 is a flowchart describing a method for identifying presence of an object according to an embodiment.

Referring to FIG. 3, according to an embodiment, the operation method may include an operation (S310) of performing calibration for the second image (e.g., the second image 102 of FIGS. 1A to 1E).

For example, when the second image is acquired, the robot (e.g., the robot 100 of FIG. 1A) may perform the calibration for the second image using a preset algorithm. For example, the robot may perform calibration for a state (e.g., an error due to a mirror attachment state or a tolerance of the robot, etc.) of the robot. Alternatively, the robot may perform calibration for a distance error due to the reflection of the image through the mirror. Alternatively, the robot may perform calibration for an image (or a mirror image) of an object due to the reflection of the image through the mirror.

According to an embodiment, the operation method may include an operation (S320) of identifying the third image (e.g., the third image 104 of FIG. 1E) corresponding to the area matching the second image in the first images corresponding to the first area (e.g., the first area 112 of FIG. 1B). For example, the second area (e.g., the second area 122 of FIG. 1B) matching the second image may be the area included in the first area.

For example, the robot may identify the third image in the first image (e.g., the first image 103 of FIG. 1E) as the captured image of the second area which is the area corresponding to the second image in the driving space. For example, the information about the second area in the driving space according to the arrangement angle of the mirror (e.g., the mirror 102 of FIG. 1A) may be stored in the memory (e.g., the memory 140 of FIG. 1A). The robot may identify the third image corresponding to the second area in the first image based on the information stored in the memory.

According to an embodiment, the operation method may include an operation (S330) of inputting the calibrated second image and the identified third image to the trained neural network model (e.g., the trained neural network model of FIGS. 1A to 1E) to identify whether the object of the liquid type (e.g., the object 10 of FIG. 1B) exists in the second area.

For example, the trained neural network model may be a model trained to output whether the object of the liquid type exists in the received image when the calibrated second image and the third image are received. Alternatively, for example, the trained neural network model may be a model trained to identify the location of the object of the liquid type when it is identified that the object of the liquid type exists.

In one example, the robot may identify whether the object 10 of the liquid type exists in the second area corresponding to the second image and the third image by inputting the calibrated second image and the identified third image to the trained neural network model. Alternatively, the robot may identify an exact location of the object of the liquid type in the second area by inputting the calibrated second image and the third image to the trained neural network model.

According to the above-described example, the robot may identify whether the object of the liquid type exists in the second area or determine (e.g., identify) an exact location of the object of the liquid type by using the second image corresponding to the second area where the calibration has been performed and the third image corresponding to the area matching the second image.

According to the above-described example, the robot may identify the object 10 of the liquid type existing in the second area by using the third image corresponding to the first capturing angle and the second image corresponding to the second capturing angle. Accordingly, the robot may identify the presence of the object 10 of the liquid type by using images of different capturing angles corresponding to the same area, and the detection rate of the object of the liquid type may be improved.

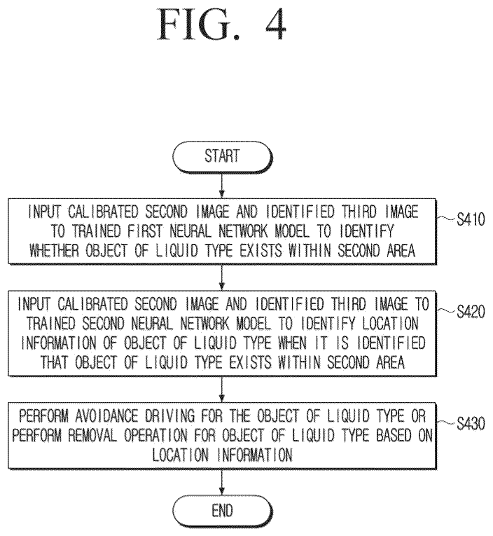

FIG. 4 is a flowchart for describing an operation of a robot related to an object according to an embodiment.

Referring to FIG. 4, according to an embodiment, the operation method may include an operation (S410) of inputting the calibrated second image (e.g., the calibrated second image of FIG. 3) and the identified third image (e.g., the third image 104 of FIG. 1E) to the trained first neural network model to identify whether the object 10 of the liquid type (e.g., the object 10 of FIG. 1B) exists in the second area (e.g., the second area 122 of FIG. 1B).

For example, the trained first neural network model may be a model trained to classify whether the object 10 of the liquid type exists in an input image when an image is input. For example, the robot (e.g., the robot 100 of FIG. 1A) may input the second image and the third image to the trained first neural network model to identify whether the object 10 of the liquid type exists in the second area corresponding to the second image and the third image.

For example, the trained first neural network model may classify whether the object 10 of the liquid type exists in each of the second image and the third image. The trained first neural network model may classify the second image as the image in which the object 10 of the liquid type exists, and may classify the third image as the image in which the object 10 of the liquid type does not exist. The robot may identify that the object 10 of the liquid type exists in the second area based on the output result.

According to an embodiment, the operation method may include an operation (S420) of inputting the calibrated second image and the identified third image to the trained second neural network model to identify the location information of the object of the liquid type when it is identified that the object 10 of the liquid type exists in the second area.

For example, the trained second neural network model may be a model trained to output the location information of the object 10 of the liquid type existing in the input image when the image is input. For example, the image input to the trained second neural network model may be an image including the object 10 of the liquid type, but is not limited thereto, and for example, the trained second neural network model may classify whether the object 10 of the liquid type exists in the image and output the location information of the object based the classification.

For example, when the robot identifies that the object 10 of the liquid type exists in the second area, the robot may input the second image and the third image to the trained second neural network model. For example, the robot may identify the location information of the object of the liquid type existing in the second area based on the output result. For example, the location information of the object of the liquid type may be the information identified based on the coordinate information for the object of the liquid type in the image corresponding to the second area, and may be the information about the location of the object of the liquid type in the second area on the driving space.

According to an embodiment, the operation method may include an operation (S430) of performing the avoidance driving for the object of the liquid type or performing the removal operation for the object of the liquid type based on the identified location information.

For example, when the location information of the object of the liquid type is identified, the robot may perform the avoidance driving for the object based on the identified location information. For example, the robot may identify a driving path based on the location information and perform the driving operation for the identified driving path. Alternatively, for example, the robot may perform the removal operation for the object 10 of the liquid type.

As an example, the trained first neural network model and the trained second neural network model may be implemented as separate neural network models, but are not limited thereto, and for example, the trained first neural network model and the trained second neural network model may be implemented as a single neural network model. For example, the robot may identify the location information of the object of the liquid type in the second area using only the trained second neural network model without performing an operation of classifying whether a separate object exists.

According to the above-described example, the robot may identify the location of the object existing in the second area using multiple capturing angle images of the second area in the driving space, and perform at least one of the avoidance operation or the removal operation based on the location information. Accordingly, the driving performance of the robot may be improved.

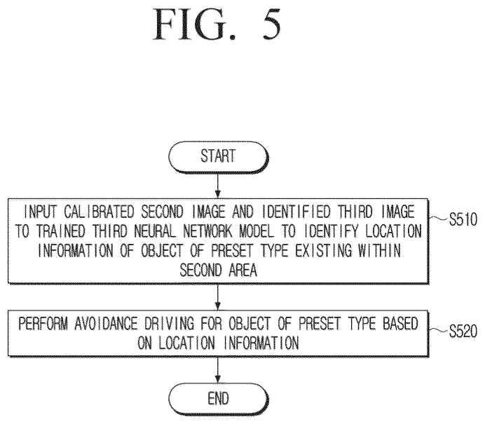

FIG. 5 is a flowchart for describing a method for performing avoidance driving for an object according to an embodiment.

Referring to FIG. 5, according to an embodiment, the operation method may include an operation (S510) of inputting the calibrated second image (e.g., the image on which the calibration is performed in FIG. 4) and the identified third image (e.g., the third image 104 in FIG. 1E) to the trained third neural network model to identify the location information of the object of the preset type existing in the second area (e.g., the second area 122 in FIG. 1B).

For example, the object of the preset type may be an object of a different type from the object of the liquid type. For example, the object of the preset type may be an object of a different type existing in a house (e.g., furniture, objects, people, animals, etc.), but is not limited thereto.

For example, the robot (e.g., the robot 100 in FIG. 1A) may input the second image and the third image to the trained third neural network model to identify the location information of the object existing in the second area. For example, the robot may identify the location information of the object of the preset type existing in the second area based on the output result acquired from the trained third neural network model.

According to an embodiment, the operation method may include an operation (S520) of performing the avoidance driving for the object of the preset type based on the identified location information.

For example, when the location information of the object of the preset type is identified, the robot may identify the driving path based on the identified location information and perform the driving operation along the identified driving path. For example, when the location information of the object of the preset type is identified in the second area, the robot may perform the avoidance driving for the identified location information.

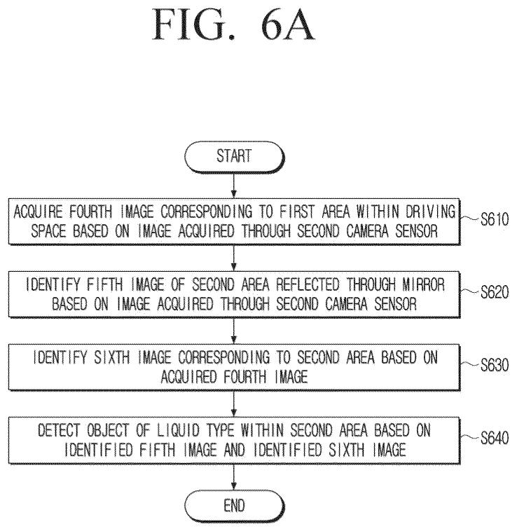

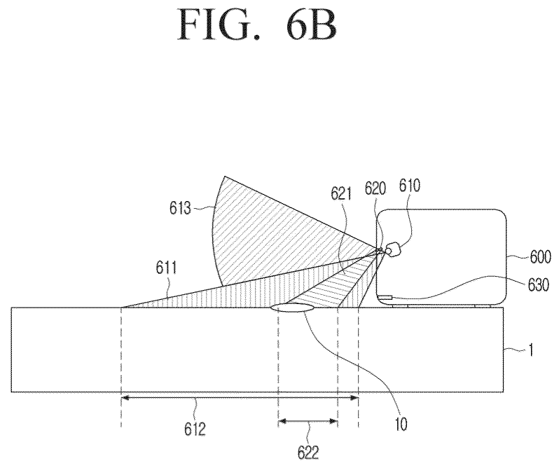

FIG. 6A is a flowchart for describing a method for identifying whether an object exists according to an embodiment. FIG. 6B is a diagram for describing the method for identifying whether an object exists according to an embodiment.

Referring to FIGS. 6A and 6B, according to an embodiment, the operation method may include an operation (S610) of acquiring a fourth image corresponding to a first area 612 (e.g., the first area 112 of FIG. 1A) within the driving space based on an image acquired through a second camera sensor 610.

For example, a robot 600 (e.g., the robot 100 of FIG. 1A) may further include a second camera sensor 610 located at a third capturing angle to capture the driving space (e.g., the driving space of FIG. 1A). For example, the third capturing angle may be a different capturing angle from the first capturing angle (e.g., the first capturing angle 114 of FIG. 1D) and the second capturing angle (e.g., the second capturing angle of FIG. 1D), but is not limited thereto, and the third capturing angle may be the same capturing angle as at least one of the first capturing angle or the second capturing angle.

For example, the second camera sensor 610 may capture the driving space of the robot 100 within a capturing range within a preset field of view (FOV) 613. For example, the driving space may include a first area 612. For example, the image corresponding to the driving space acquired (or captured) through the second camera sensor 610 may include an image corresponding to the first area 612 within the driving space of the robot 600.

For example, the first area 612 may be an area in a driving space corresponding to a capturing range 611 between the capturing direction corresponding to the second camera sensor 610 and the field of view 613. For example, the first area 612 may be an area within a preset range of distances from the robot 600. For example, the first area 612 may be at least a portion of an area that may be captured through the second camera sensor 610.

For example, the robot 600 may acquire a fourth image as an image of an area corresponding to the first area among images (or images corresponding to the driving space) acquired through the second camera sensor 610.

According to an embodiment, the operation method may include an operation (S620) of identifying a fifth image reflected through a mirror 620 of a second area 622 (e.g., the second area 122 of FIG. 1B) based on the image (or image corresponding to the driving space) acquired through the second camera sensor 610.

According to an embodiment, the mirror 620 may be arranged at a second arrangement angle at a second location of the robot 600. In one example, the mirror 620 may be a different mirror from the mirror (e.g., the mirror 120 of FIG. 1B) corresponding to the first camera sensor (e.g., the first camera sensor 110 of FIG. 1B). In one example, the second arrangement angle may be different from the first arrangement angle illustrated in FIG. 1D, but is not limited thereto.

In one example, the second location may be included in an area corresponding to the field of view 613 and may be located relatively higher than the second camera sensor 610. In one example, the area corresponding to the field of view 613 may be an area located within the field of view 613 and included in an image acquired through the second camera sensor 610. For example, the mirror 620 may be included in an area corresponding to the field of view 613, but is not limited thereto, and a portion of the mirror 620 may be included in an area corresponding to the field of view 613.

For example, the second camera sensor 610 may be implemented as a stereo camera including camera sensors corresponding to each of the left eye and the right eye, and the first camera sensor may be implemented as a red, green, and blue (RGB) camera sensor, but is not limited thereto, and when the first camera sensor is implemented as a stereo camera, the second camera sensor 610 may be implemented as the RGB camera sensor.

For example, when the robot 600 includes each of the first camera sensor and the second camera sensor 610, the first camera sensor and the second camera sensor 610 may be arranged at different locations within the robot 600. For example, when the first camera sensor is implemented as an RGB camera, the first camera sensor may be arranged at a location corresponding to a preset height (e.g., 63 mm (millimeter)) from the ground 1. For example, when the second camera sensor 610 is implemented as the stereo camera, the second camera sensor 610 may be arranged within the robot 600 at a preset angle (tilted angle) at a preset height (e.g., 46 mm) from the ground 1.

For example, when the robot 600 includes the second camera sensor 610, the robot 600 may include a light-emitting element 630 (e.g., a light emitting diode (LED)) that emits light of a preset wavelength band (e.g., an infrared wavelength band). However, the present disclosure is not limited thereto, and a wavelength band (or a frequency band corresponding thereto) corresponding to the light-emitting element may be an effective wavelength band for detecting the object 10 of the liquid type. For example, the light-emitting element may be arranged at a location corresponding to a preset height (e.g., 34.5 mm) from the ground 1 within the robot 600, but is not limited thereto.

For example, when the second camera sensor 610 includes camera sensors corresponding to the left and right eyes, respectively, the mirrors 620 corresponding to each camera sensor may be arranged within the robot 600. For example, the mirror 620 corresponding to the left eye and the mirror 620 corresponding to the right eye may each be arranged at preset locations within the robot 600. For example, when the robot 600 includes the first camera sensor and the second camera sensor 610, respectively, at least three mirrors 620 may be arranged within the robot 600, and the robot 600 may identify an image reflected through each mirror 620 and use the same to identify the object 10 of the liquid type existing within the driving space.

For example, when the image corresponding to the driving space is acquired through the second camera sensor 610, the robot 600 may identify the fifth image in which the second area 622 is reflected through the mirror 620 among the acquired images. In one example, a memory (e.g., memory 140 of FIG. 1A) may store coordinate information for an image corresponding to the mirror 620 among the images corresponding to the driving space acquired through the second camera sensor 610. The robot 600 may identify the fifth image from the image corresponding to the driving space based on the information stored in the memory.

In one example, the fourth image may be an image captured at the third capturing angle corresponding to the second camera sensor 610. In one example, the fifth image may be an image corresponding to a fourth capturing angle at which the second area 622 is reflected through a mirror 620. For example, the fourth capturing angle may be the capturing angle corresponding to the arrangement angle of the mirror 620. For example, the fifth image corresponding to the second area 622 may be included in the image corresponding to the driving space acquired through the second camera sensor 610.

For example, the second area 622 may be an area reflected through the mirror 620 based on the second camera sensor 610. For example, the second area 622 may be an area on the driving space corresponding to the reflection range 621 of light reflected through the mirror 620 among light incident on the second camera sensor 610.

According to an embodiment, the operation method may include an operation (S630) of identifying a sixth image corresponding to the second area 622 based on the fourth image.

For example, the robot 600 may identify the sixth image corresponding to the second area 622 among the fourth images corresponding to the first area 612. For example, the sixth image may be an image in which the second area 622 is captured at the third capturing angle. For example, the memory may store coordinate information for an image corresponding to the second area 622 among the fourth images. The robot 600 may identify the sixth image from the fourth image based on the information stored in the memory.

According to an embodiment, the method of operation may include an operation (S640) of detecting the object 10 of the liquid type (e.g., the object 10 of the liquid type of FIG. 1B) within the second area 622 based on the identified fifth image and the identified sixth image.

For example, the robot 600 may input the identified fifth image and the identified sixth image into the trained neural network model (e.g., the trained neural network model of FIG. 1A) to detect the object 10 of the liquid type within the second area 622. For example, the robot 600 may input the fifth image and the sixth image to the trained neural network model to identify whether the object exists in at least one of the fifth image or the sixth image. Alternatively, for example, the robot 600 may input the fifth image and the sixth image to the trained neural network model to identify the location information (e.g., location information of FIG. 1A) of the object 10 of the liquid type existing in the second area 622.

For example, the robot 600 may detect the object 10 of the liquid type within the driving space based on each of the identified second image, the identified third image, the identified fifth image, and the identified sixth image. For example, the robot 600 may input each of the identified second image, the identified third image, the identified fifth image, and the identified sixth image to the trained neural network model (e.g., the trained first neural network model of FIG. 4) to classify at least one image including the object 10 of the liquid type.

For example, when at least one image including the object 10 of the liquid type is classified, the robot 600 inputs the at least classified image to the trained neural network model (e.g., the trained second neural network model of FIG. 4) to identify the location information of the object 10 of the liquid type. For example, the robot 600 may perform the avoidance driving or the removal operation for the object based on the identified location information.

According to the above-described example, the robot 600 may identify the object 10 of the liquid type existing in the second area 622 using the second camera sensor 610 and perform the avoidance driving or the removal operation for the object based on the identified location information. The robot 600 may more accurately detect an object existing on the driving path of the robot 600 through a plurality of camera sensors.

FIG. 7A is a flowchart for describing a method for identifying whether an object exists according to an embodiment. FIGS. 7B and 7C are diagrams for describing a method for identifying whether an object exists according to an embodiment.

Referring to FIGS. 7A to 7C, according to an embodiment, the operation method may include an operation (S710) of identifying a seventh image corresponding to a third area among the second images (e.g., the second image 102 of FIG. 1E).

For example, a first arrangement angle (e.g., the first arrangement angle 115 of FIG. 1D) corresponding to a mirror 720 (e.g., the mirror 120 of FIG. 1B) may satisfy the following math FIG. 1.

$$\frac{π}{2} - A \leq B \leq \frac{π}{2} \qquad [ Math Figure 1 ]$$

In the above math FIG. 1, ‘A’ may be a first capturing angle (e.g., the first capturing angle 114 of FIG. 1D) or a third capturing angle (e.g., the third capturing angle of FIG. 6A). For example, ‘B’ may be the first arrangement angle. In one example, when the mirror 720 is arranged in a robot 700 (e.g., the robot 100 of FIG. 1A) so that the first arrangement angle satisfies the math FIG. 1 described above, a second area 722 (e.g., the second area 122 of FIG. 1B) may be included in a first area 712 (e.g., the first area 112 of FIG. 1B).

In one example, the first area 712 may be an area in a driving space corresponding to a capturing range 711 between the capturing direction and the field of view 713 corresponding to the camera sensor 710 (e.g., at least one of the first camera sensor 110 of FIG. 1A or the second camera sensor 610 of FIG. 6B). For example, when the camera sensor 710 is implemented as a stereo camera (e.g., the second camera sensor 610 of FIG. 6B), the robot 700 may include a light-emitting element (e.g., the light-emitting element 630 of FIG. 6B).

For example, the second area 722 may be an area reflected through the mirror 720 based on the second camera sensor 710. For example, the second area 722 may be an area in a driving space corresponding to the reflection range 721 of light reflected through the mirror 720 among light incident on the camera sensor 710.

For example, the second area 722 may include a third area that is at a preset distance or more from the robot 700. For example, the robot 700 may identify a seventh image corresponding to the third area among the second areas 722 reflected through the mirror 720 from among the second images.

For example, as the first arrangement angle corresponding to the mirror 720 increases, the range of the area reflected through the mirror 720 may become relatively wider. For example, when the arrangement angle of the mirror 720 is greater than or equal to a preset angle (or, when the range of the area reflected through the mirror 720 is relatively wide) while satisfying the above math FIG. 1, the robot 700 may divide the area reflected through the mirror 720 into multiple areas and detect an object 10 of a liquid type based on the images corresponding to each of the multiple divided areas.

For example, unlike as illustrated in FIG. 1B, when the first arrangement angle satisfies math FIG. 1 and is larger than the preset angle, the size of the second area 722 may be relatively large as illustrated in FIG. 7B. For example, when the first arrangement angle is larger than the preset angle, as illustrated in FIG. 9B below, the second area 722 may not be included in the first area 712. This will be described below.

According to an embodiment, the operation method may include an operation (S720) of detecting the object 10 of the liquid type within the third area based on the identified seventh image and the identified third image (e.g., the third image 104 of FIG. 1E).

For example, the robot 700 may input the seventh image corresponding to the third area and the third image into the trained neural network model (e.g., the trained neural network model of FIG. 1A) to identify whether the object 10 of the liquid type exists in the third area. For example, the robot 700 may perform calibration (e.g., the calibration of FIG. 3) for the seventh image and input the calibrated seventh image to the trained neural network model. For example, the robot 700 may extract an image corresponding to the third area in the third image and input the extracted image together with the seventh image to the trained neural network model to identify whether the object 10 of the liquid type exists in the third area.

For example, the robot 700 may only perform an operation of classifying an image (e.g., classification in FIG. 4) based on the presence or absence of the object 10 of the liquid type in the third area (or a distant area), and perform a classification operation and a location information (e.g., location information in FIG. 4) identification operation for the remaining areas (or a close area) of the second area 722 excluding the third area. Thereafter, when the robot 700 performs the driving operation and is identified as being less than a preset distance from the third area, the robot 700 may identify the location information of the object existing in the third area and perform the driving operation based on the identified location information.

According to the above-described example, the robot 700 may perform an operation of identifying the presence or absence of an object and an operation of identifying a location of an object in an area existing within a preset distance from the robot 700, and may only perform an operation of identifying the presence or absence of an object in an area that is greater than a preset distance from the robot 700. Accordingly, it is possible to reduce the amount of data processing for object detection of the robot 700, and efficiently control the robot 700.

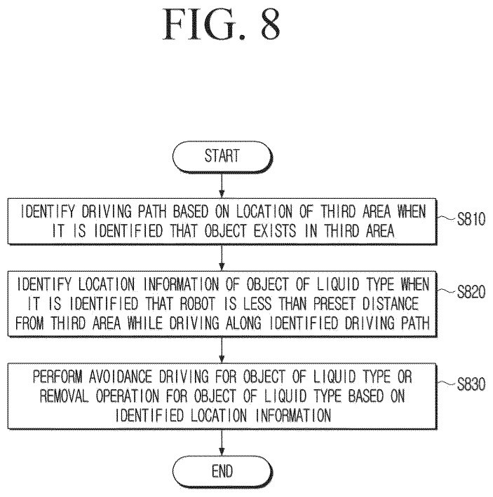

FIG. 8 is a flowchart for describing an operation of a robot related to an object according to an embodiment.

Referring to FIG. 8, according to an embodiment, the operation method may include an operation (S810) for identifying a driving path based on the location of the third area when it is identified that an object (e.g., the object 10 of the liquid type of FIG. 1B) exists in a third area (e.g., the third area of FIG. 7a).

For example, the robot (e.g., the robot 100 of FIG. 1A) may identify whether the object exists in the third area based on a seventh image (e.g., the seventh image of FIG. 7A) and the third image (e.g., the third image 104 of FIG. 1E) corresponding to the third area. In one example, when the robot is identified as an object existing within the third area, the robot may identify a driving path based on the location of the third area. For example, the robot may identify a driving path for approaching the third area. Alternatively, for example, the robot may identify a driving path for passing through the third area.

In an embodiment, the operation method may include an operation (S820) of identifying location information (e.g., location information of FIG. 4) of the object 10 of the liquid type when the robot is identified as being less than a preset distance from the third area while driving along the identified driving path.

In one example, when the robot is identified as being less than a preset distance from the third area while performing the driving operation, the robot may input a seventh image corresponding to the third area and the third image into the trained neural network model (e.g., the trained neural network model of FIG. 4) to identify the location information of the object.

According to an embodiment, the operation method may include an operation (S830) of performing the avoidance driving for the object of the liquid type or performing the removal operation for the object of the liquid type based on the location information.

For example, when the location information of the object existing in the third area is identified, the robot may perform the avoidance driving for the object or perform the removal operation for the object based on the location information of the object.

However, the present disclosure is not limited thereto, and for example, even when the object exists in the third area, when the third area is not included in the existing driving path of the robot, the robot may perform the operation regardless of the location of the object.

According to the above-described example, the robot may perform an operation of identifying the presence or absence of an object and an operation of identifying a location of an object in an area existing within a preset distance from the robot, respectively, and may only perform an operation of identifying the presence or absence of an object in an area that is greater than a preset distance from the robot. Accordingly, it is possible to reduce the amount of data processing for object detection of the robot, and efficiently control the robot.

FIG. 9A is a flowchart for describing a method for identifying whether an object exists according to an embodiment. FIG. 9B is a diagram for describing the method for identifying whether an object exists according to an embodiment.

Referring to FIGS. 9A and 9B, according to an embodiment, the operation method may include an operation (S910) for identifying a second image (e.g., the second image 102 of FIG. 1E) reflected through a mirror 920 (e.g., the mirror 120 of FIG. 1B) arranged at a second arrangement angle in a second area 931 (e.g., the second area 122 of FIG. 1B) within a driving space based on an image (e.g., the image 101 corresponding to the driving space of FIG. 1E) acquired through a first camera sensor 910 (e.g., the first camera sensor 110 of FIG. 1A).

For example, a robot 900 (e.g., the robot 100 of FIG. 1A) may acquire the image corresponding to the driving space through the first camera sensor 910. For example, the robot 900 may identify the second image in which the second area 931 is reflected through the mirror 920 among images corresponding to the driving space.

However, the present disclosure is not limited thereto, and for example, the robot 900 may acquire an image corresponding to the driving space through a second camera sensor (e.g., the second camera sensor 610 of FIG. 6B) and identify the second image based on the acquired image. However, for convenience of description, the following description will be limited to a case in which the image corresponding to the driving space is acquired through the first camera sensor.

According to an embodiment, the operation method may include an operation (S920) of identifying an eighth image corresponding to a fourth area 932 that is not included in the first area 912 (e.g., the first area 112 of FIG. 1B) in the second area based on the second image.

For example, the first area 912 may be an area in a driving space corresponding to a capturing range 911 between the capturing direction corresponding to the first camera sensor 910 and the field of view 913.

For example, the second area 931 may be an area reflected through the mirror 920 based on the first camera sensor 910. For example, the second area 931 may be an area on the driving space corresponding to the reflection range 920 of light reflected through the mirror 920 among light incident on the first camera sensor 910.

For example, the second arrangement angle corresponding to the mirror 920 (e.g., the mirror 120 of FIG. 1B) may satisfy the following math FIG. 2.

$$0 < C < \frac{π}{2} - A \qquad [ Math Figure 2 ]$$

In the above math FIG. 2, ‘A’ may be a first capturing angle (e.g., the first capturing angle 114 of FIG. 1D) or a third capturing angle (e.g., the third capturing angle of FIG. 6A). For example, ‘C’ may be the second arrangement angle. For example, when the mirror 920 is arranged in the robot 900 so that the second arrangement angle satisfies the math FIG. 2 described above, some area 933 of the second area 931 may be included in the first area 912, and the remaining area 932 (or the fourth area) may not be included in the first area 912. For example, the first arrangement angle (e.g., the first arrangement angle 115 of FIG. 1D) and the second arrangement angle may be different.

For example, as the second arrangement angle corresponding to the mirror 920 becomes smaller, the range of the area reflected through the mirror 920 may become relatively narrower. For example, when the second arrangement angle becomes smaller, a blind area may exist as an area 932 that is out of the field of view 913 of the first camera sensor 910. Alternatively, according to an example, when the second arrangement angle becomes smaller, only a portion of the area 933 may be included in the first area 912 as described above.

For example, the second area 931 may include the fourth area 932 that is less than a preset distance from the robot 900. For example, the robot 900 may identify an eighth image corresponding to the fourth area 932 in the second area 931 reflected through the mirror 920 among the second images. For example, the robot 900 may identify the eighth image corresponding to the fourth area 932 among the second images using the coordinate information corresponding to the fourth area 932. For example, the coordinate information corresponding to the fourth area 932 may be stored in a memory (e.g., the memory 140 of FIG. 1A).

According to an embodiment, the operation method may include an operation (S930) of identifying whether an object exists in the fourth area 932 based on the eighth image.

For example, when the eighth image corresponding to the fourth area is identified, the robot 900 inputs the identified eighth image to the trained neural network model (e.g., at least one of the trained first neural network model of FIG. 4 or the trained third neural network model of FIG. 5) to identify whether the object 10 of the liquid type exists in the fourth area.

For example, the robot 900 may identify whether the object 10 of the liquid type exists in the fourth area, but is not limited thereto, and the robot may also identify the location information of the object of the preset type (e.g., the object of the preset type of FIG. 5) in the fourth area.

For example, the robot 900 may simultaneously perform an operation of identifying whether the object 10 of the liquid type exists in the fourth area and an operation of identifying location information of the object of the preset type in the fourth area. For example, the robot 900 may identify the location information of the object 10 of the liquid type when it is identified that the object 10 of the liquid type exists within the fourth area.

For example, the robot 900 may perform a rotation operation of the robot based on whether the object is detected within the fourth area. For example, the robot 900 may perform the rotation operation when it is identified that the object does not exist within the fourth area. For example, it may be assumed that the robot 900 is to perform the rotation operation in the fourth area to provide a service. The robot 900 may detect whether the object exists within the fourth area, and when it is identified that the object does not exist, may perform a rotation operation in the fourth area. For example, when the object exists within the fourth area, the robot 900 may perform the avoidance operation for the object or the removal operation for the object without performing the rotation operation.

Returning to FIG. 2, according to an embodiment, the processor 130 may compare the location of the first object in the second image and the location of the second object in the third image when a first object of a liquid type is detected in the second image and a second object of a liquid type is detected in the third image.

For example, the processor 130 may input each of the identified second image and the identified third image to the trained neural network model. For example, the processor 130 may detect the first object of the liquid type in the second image and detect the second object of the liquid type in the third image based on the output results.

For example, the processor 130 may identify the location of the first object and the location of the second object, respectively. For example, the processor 130 may identify the location of each object in the second area based on the output results for the trained neural network model. For example, the processor 130 may compare the respective locations.

According an embodiment, the processor 130 may determine whether the first object and the second object are the same object based on the comparison result. For example, when the first object and the second object are identified as existing at the same location (or within a preset error range), the processor 130 may determine that the first object and the second object are the same object.

According to an embodiment, when the processor 130 determines that the first object and the second object are the same object, the processor 130 may determine that the object exists in the second area. The processor 130 may perform the avoidance driving for the object or perform the removal operation for the object based on the location of the object existing in the second area.

According to the above-described example, the robot 100 may detect the presence or absence of the object using multiple images for the same area. Accordingly, the presence or absence of the object and the location of the object may be accurately identified, thereby improving the performance of the robot 100.

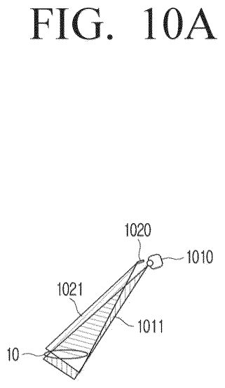

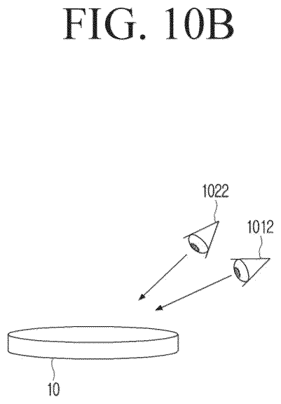

FIGS. 10A and 10B are diagrams for describing the role of a mirror according to an embodiment.

Referring to FIGS. 10A and 10B, according to an embodiment, a robot (e.g., a robot 100 of FIG. 1A) may include a camera sensor 1010 (e.g., the first camera sensor 110 of FIG. 1A or a second camera sensor 610 of FIG. 6B).

For example, the camera sensor 1010 may capture the object 10 of the liquid type existing within a first capturing range 1011 at a first angle 1012.

For example, a mirror 1020 may be arranged in the robot at a preset arrangement angle (e.g., a first arrangement angle of FIG. 1B). For example, among the light reflected through the mirror 1020, light within a first reflection range 1021 may be incident on the camera sensor 1010 through the mirror 1020.

For example, when the object 10 of the liquid type exists in an area corresponding to the first reflection range 1021, the object 10 of the liquid type may be captured at a second angle 1022 through the mirror 1020. For example, when light within the first reflection range 1021 is incident on the camera sensor 1010 through the mirror 1020, an image output through the camera sensor 1010 may include an image of the object 10 of the liquid type captured at the second angle 1022.

According to the above-described example, the robot of the present disclosure may acquire images captured at different angles for the same area, and detect the object 10 within the area using the acquired images of different angles. In the case of the object 10 of the liquid type, whether the object 10 is detected may vary depending on the capturing angle. According to the above-described example, since the object 10 of the liquid type may be captured at different capturing angles, the detection rate of the object 10 may increase.

Returning to FIG. 2, according to an embodiment, the first arrangement angle 115 of the mirror 120 may be changed based on the context information of the robot 100. For example, the context information of the robot 100 may include at least one of the driving speed of the robot 100, the operation mode of the robot 100, information about the area of interest of the robot 100, and information about the driving space. For example, the area of interest of the robot 100 may be, but is not limited to, the second area 122. For example, the information about the driving space may include information about a terrain slope corresponding to the driving space.

For example, the processor 130 may identify the first arrangement angle 115 of the mirror 120 based on the driving speed of the robot 100. For example, when the driving speed of the robot 100 increases based on a preset event (e.g., an event of avoidance driving for an object or a turning driving event), the processor 130 may identify the first arrangement angle 115 so that the location of the second area 122 exists at a location relatively far from the robot 100 compared to the existing location. Alternatively, for example, when the driving speed of the robot 100 decreases, the processor 130 may identify the first arrangement angle 115 for the location of the second area 122 to be relatively closer to the robot 100 than the existing location.

For example, the processor 130 may also identify the first arrangement angle 115 of the mirror 120 based on the information about the operation mode of the robot 100. For example, when the robot 100 operates in a ‘high-speed cleaning mode’, the processor 130 may identify the first arrangement angle 115 for the location of the second area 122 to be relatively farther from the robot 100 than the existing location. Alternatively, for example, the processor 130 may identify the first arrangement angle 115 for the location of the second area 122 to be relatively closer to the robot 100 than the existing location when the robot 100 operates in the ‘high precision cleaning mode’.

For example, the processor 130 may also identify the first arrangement angle 115 of the mirror 120 based on the information about the driving space. For example, the processor 130 may identify the first arrangement angle 115 for the location of the second area 122 to be relatively closer to the robot 100 than the existing location when the robot 100 drives on steep terrain. Alternatively, the processor 130 may identify the first arrangement angle 115 for the second area 122 to be located at a location that is relatively farther away from the robot 100 than the existing location when the robot 100 is driving downhill.

For example, the processor 130 may identify the first arrangement angle 115 of the mirror 120 based on the output result from the trained neural network model. For example, it may be assumed that an image corresponding to a specific area within the driving space is input to the trained neural network model. When it is determined that it is uncertain whether an object exists in the specific area described above based on the output result from the trained neural network model, the processor 130 may identify the first arrangement angle 115 for acquiring an additional image for the specific area described above.

For example, the robot 100 may further include a driving unit (e.g., a motor) for changing the arrangement angle of the mirror 120. For example, when the first arrangement angle 115 of the mirror 120 is identified, the robot 100 may control the driving unit so that the mirror 120 is arranged at the identified first arrangement angle 115. For example, the robot 100 may change the first arrangement angle 115 of the mirror 120 in real time based on context information of the robot 100, even when the robot is driving in the driving space.

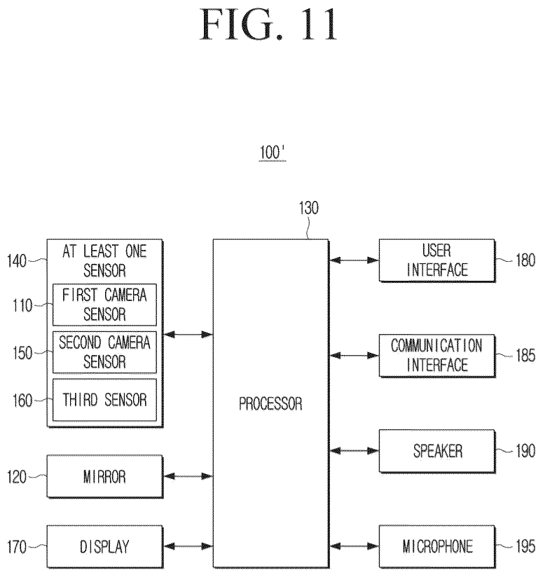

FIG. 11 is a block diagram illustrating a detailed configuration of a robot according to an embodiment.

Referring to FIG. 11, a robot 100′ may include at least one sensor 145 including the first camera sensor 110, the second camera sensor 150 (e.g., the second camera sensor 610 of FIG. 6B) and a third sensor 160, the mirror 120, at least one processor 130, the memory 140, a display 170, a user interface 180, a communication interface 185, a speaker 190, and a microphone 195. A detailed description for components overlapped with components illustrated in FIG. 2 among components illustrated in FIG. 11 will be omitted.

At least one sensor 145 may include different types of sensors including the first camera sensor 110, the second camera sensor 150, and the third sensor 160. At least one sensor 145 may include a plurality of sensors of various types. The third sensor 160 may measure physical quantities or detect the operating status of the robot 100′ and convert the measured or detected information into an electrical signal. The third sensor 160 may include a camera, and the camera may include a lens for focusing visible light and other optical signals received after being reflected by an object into an image sensor, and an image sensor capable of detecting visible light and other optical signals. The image sensor may include a 2D pixel array divided into a plurality of pixels. Alternatively, the third sensor 160 may include a temperature sensor or an infrared sensor.

The display 170 may be implemented as a display including a self-light emitting element or a display including a non-light emitting element and a backlight. For example, the display 170 may be implemented as various types of displays such as a liquid crystal display (LCD), an organic light emitting diodes (OLED) display, light emitting diodes (LED), a micro LED, a Mini LED, a plasma display panel (PDP), a quantum dot (QD) display, and quantum dot light-emitting diodes (QLED). A driving circuit, a backlight unit, and the like, that may be implemented in the form such as an a-si thin film transistor (TFT), a low temperature poly silicon (LTPS), a TFT, an organic TFT (OTFT), and the like, may be included in the display 170. The display 170 may be implemented as a touch screen coupled with a touch sensor, a flexible display, a rollable display, a 3D display, a display to which a plurality of display modules are physically connected, and the like. The processor 130 may control the display 170 to output the output image acquired according to various embodiments described above. The output image may be a high-resolution image of 4K or 8K or higher. The output image may be a game image according to an embodiment.

According to an embodiment, the display 170 may include a plurality of haptic elements. The haptic element may be implemented as a motor for providing haptic feedback (e.g., vibration feedback) to a user, but are not limited thereto. For example, the display 170 may include a preset number of haptic elements. For example, the display 170 may include a preset number of haptic elements corresponding to a preset number of sub-areas of the display, but is not limited thereto, and it is of course possible for the display to include a different number of haptic elements than the number of sub-areas corresponding to the display.

The user interface 180 is a component for the robot 100′ to perform an interaction with a user. For example, the user interface 180 may include at least one of a touch sensor, a motion sensor, a button, a jog dial, a switch, a microphone, or a speaker, but is not limited thereto.

The communication interface 185 may input and output various types of data. For example, the communication interface 185 may transmit and receive various types of data to and from an external device (e.g., source device), an external storage medium (e.g., USB memory), an external server (e.g., web hard), etc., through communication methods such as AP-based Wi-Fi (wireless LAN network), Bluetooth, Zigbee, a wired/wireless local area network (LAN), a wide area network (WAN), Ethernet, IEEE 1394, a high-definition multimedia interface (HDMI), a universal serial bus (UBS), a mobile high-definition link (MHL), an audio engineering society/European broadcasting union (AES/EBU), optical, and coaxial.

According to an example, the communication interface 185 may include a Bluetooth low energy (BLE) module. The BLE refers to a Bluetooth technology that enables transmission and reception of low-power, low-capacity data in a 2.4 GHz frequency band with a reach radius of approximately 10 m. However, it is not limited thereto and the communication interface 185 may also include a Wi-Fi communication module. That is, the communication interface 185 may include at least one of the Bluetooth low energy (BLE) module or the Wi-Fi communication module.

According to an embodiment, the speaker 190 may include a tweeter for high-pitched sound reproduction, a mid-range sound for mid-range sound reproduction, a woofer for low-pitched sound reproduction, a subwoofer for extremely low-pitched sound reproduction, an enclosure for controlling resonance, a crossover network that divides an electric signal frequency input to the speaker by band, etc.

According to an embodiment, the speaker 190 may output a sound signal to the outside of the robot 100′. The speaker 190 may output multimedia reproduction, recording reproduction, various kinds of notification sounds, voice messages, and the like. The robot 100′ may include an audio output device such as the speaker 190, or may include an output device such as the audio output terminal. In particular, the speaker 190 may provide acquired information, information processed/produced based on the acquired information, a response result to a user's voice, an operation result, or the like in the form of voice.

The microphone 195 may refer to a module that acquires sound and converts the acquired sound into an electrical signal, and may be a condenser microphone, a ribbon microphone, a moving coil microphone, a piezoelectric element microphone, a carbon microphone, or a micro electro mechanical system (MEMS) microphone. In addition, it may be implemented in non-directional, bi-directional, unidirectional, sub-cardioid, super-cardioid, and hyper-cardioid ways. According to an embodiment, the robot 100′ may include a microphone 195 and an inner microphone, and the microphone 195 may be a microphone located relatively outside the body. For example, the robot 100′ may acquire an audio signal including external noise through the microphone 195. According to an embodiment, the microphone 195 may be arranged in a direction opposite to the direction in which the speaker 190 emits sound.

According to the above-described example, the robot 100′ of the present disclosure may detect a liquid through images captured at multiple capturing angles for a specific area in the driving space, and thus may detect the liquid with a high detection rate.

The above-described methods according to various embodiments of the present disclosure may be implemented in a form of application that can be installed in the existing robot. Alternatively, the above-described methods according to various embodiments of the present disclosure may be performed using a deep learning-based learned neural network (or deep learned neural network), that is, a learning network model. In addition, the above-described methods according to various embodiments of the present disclosure may be implemented only by software upgrade or hardware upgrade of the existing robot. In addition, various embodiments of the present disclosure described above can be performed through an embedded server provided in the robot or a server outside the robot.

According to an embodiment of the disclosure, the diverse embodiments described above may be implemented as software including instructions stored in a machine-readable storage medium (e.g., a computer-readable storage medium). A machine may be a device that invokes the stored instruction from the storage medium and may be operated depending on the invoked instruction, and may include the display device (for example, the display device A) according to the disclosed embodiments. When the instruction is executed by a processor, the processor may perform the function corresponding to the instruction directly or by using other components under the control of the processor. The command may include codes provided or executed by a compiler or an interpreter. The machine-readable storage medium may be provided in a form of a non-transitory storage medium. The term “non-transitory” means that the storage medium is tangible without including a signal, and does not distinguish whether data are semi-permanently or temporarily stored in the storage medium.

In addition, according to an embodiment, the above-described methods according to the diverse embodiments may be included and provided in a computer program product. The computer program product may be traded as a product between a seller and a purchaser. The computer program product may be distributed in the form of a storage medium (e.g., a compact disc read only memory (CD-ROM)) that may be read by the machine or online through an application store (e.g., PlayStore™). In case of the online distribution, at least a portion of the computer program product may be at least temporarily stored in a storage medium such as a memory of a server of a manufacturer, a server of an application store, or a relay server or be temporarily provided.

In addition, each of components (e.g., modules or programs) according to the diverse embodiments described above may include a single entity or a plurality of entities, and some of the corresponding sub-components described above may be omitted or other sub-components may be further included in the diverse embodiments. Alternatively or additionally, some of the components (e.g., the modules or the programs) may be integrated into one entity, and may perform functions performed by the respective corresponding components before being integrated in the same or similar manner. Operations performed by the modules, the programs, or other components according to the diverse embodiments may be executed in a sequential manner, a parallel manner, an iterative manner, or a heuristic manner, at least some of the operations may be performed in a different order or be omitted, or other operations may be added.

Although example embodiments of the present disclosure have been illustrated and described above, the present disclosure is not limited to the above-described specific example embodiments, but may be variously modified by those skilled in the art to which the present disclosure pertains without departing from the gist of the present disclosure as disclosed in the accompanying claims. These modifications should also be understood to fall within the scope and spirit of the present disclosure.

What is claimed is:

1. A robot, comprising:
a first camera sensor arranged at a first capturing angle to capture a driving space of the robot;
a mirror arranged at a first arrangement angle at a first location of the robot;
at least one processor including a processing circuit; and
a memory storing instructions, and including one or more storage media,
wherein the instructions, when individually or collectively executed by the at least one processor, cause the robot to:
acquire, using the first camera sensor, a first image corresponding to a first area within the driving space;
identify, based on the first image, a second image, corresponding to a second capturing angle, in which a second area within the driving space is reflected by the mirror;
identify a third image of the second area captured at the first capturing angle based on the acquired first image; and
identify an object of a liquid type within the second area based on the second image corresponding to the second capturing angle and the third image corresponding to the first capturing angle.

2. The robot as claimed in claim 1, wherein the first capturing angle is an angle at which the first camera sensor is tilted with respect to a line perpendicular to a ground, and
wherein the second capturing angle is a capturing angle corresponding to a reflected image that is reflected by the mirror arranged at the first arrangement angle.

3. The robot as claimed in claim 1, wherein the first area includes the second area, and
wherein the instructions, when individually or collectively executed by the at least one processor, cause the robot to:
calibrate the second image;
identify the third image corresponding to an area matching the second image among the first image corresponding to the first area; and
provide the calibrated second image and the identified third image to a first trained neural network model to identify whether the object of the liquid type exists within the second area.

4. The robot as claimed in claim 3, wherein the instructions, when individually or collectively executed by the at least one processor, cause the robot to:
provide the calibrated second image and the identified third image to a trained second neural network model to identify whether the object of the liquid type exists within the second area;
provide the calibrated second image and the identified third image to a trained third neural network model to identify location information of the object of the liquid type based on identifying that the object of the liquid type exists within the second area; and
perform at least one of avoidance driving for the object of the liquid type or a removal operation for the object of the liquid type based on the identified location information.

5. The robot as claimed in claim 3, wherein the instructions, when individually or collectively executed by the at least one processor, cause the robot to:
provide the calibrated second image and the identified third image to a trained fourth neural network model to identify location information of another object of a preset type existing within the second area; and
perform avoidance driving for the another object of the preset type based on the identified location information.

6. The robot as claimed in claim 1, wherein the first location is included in an area corresponding to a field of view of the first camera sensor, and is a relatively higher location than the first camera sensor.

7. The robot as claimed in claim 1, further comprising:
a second camera sensor arranged at a third capturing angle to capture the first area,
wherein the instructions, when individually or collectively executed by the at least one processor, cause the robot to:
acquire, using the second camera sensor, a fourth image corresponding to the first area within the driving space;
identify a fifth image of the second area reflected by the mirror based on the fourth image;
identify a sixth image corresponding to the second area based on the acquired fourth image; and
identify the object of the liquid type within the second area based on the identified fifth image and the identified sixth image.

8. The robot as claimed in claim 7, wherein the first camera sensor is implemented as a red, green, and blue (RGB) camera, and
wherein the second camera sensor is implemented as a stereo camera including camera sensors corresponding to a left eye and a right eye, respectively, and
wherein the instructions, when individually or collectively executed by the at least one processor, cause the robot to identify the object of the liquid type within the driving space based on each of the identified second image, the identified third image, the identified fifth image, and the identified sixth image.

9. The robot as claimed in claim 1, wherein the second area further includes a third area that is a distance greater than a preset distance from the robot, and
wherein the instructions, when individually or collectively executed by the at least one processor, cause the robot to:
identify a seventh image corresponding to the third area among the second image; and
identify the object of the liquid type within the third area based on the identified seventh image and the identified third image.

10. The robot as claimed in claim 9, wherein the instructions, when individually or collectively executed by the at least one processor, cause the robot to:
identify a driving path based on a location of the third area based on identifying that the object exists in the third area; and
identify location information of the object of the liquid type based on identifying that the robot is less than the preset distance from the third area while driving along the identified driving path; and
perform at least one of avoidance driving for the object of the liquid type or a removal operation for the object of the liquid type based on the identified location information.

11. The robot as claimed in claim 1, wherein the mirror is arranged at a second arrangement angle different from the first arrangement angle, and
wherein the instructions, when individually or collectively executed by the at least one processor, cause the robot to:
identify, using the first camera sensor, the second image of the second area within the driving space reflected by the mirror arranged at the second arrangement angle;
identify an eighth image corresponding to a fourth area, which is not included in the first area, in the second area, based on the second image; and
identify whether another object exists within the fourth area based on the eighth image.

12. The robot as claimed in claim 11, wherein the fourth area is a blind area that is out of a field of view of the first camera sensor, and
wherein the instructions, when individually or collectively executed by the at least one processor, cause the robot to perform a rotation operation of the robot based on whether the object is identified within the fourth area.

13. The robot as claimed in claim 1, wherein the instructions, when individually or collectively executed by the at least one processor, cause the robot to:
compare a location of a first object within the second image and a location of a second object within the third image based on the first object of the liquid type being identified within the second image and the second object of the liquid type being identified within the third image; and
identify whether the first object and the second object are a same object based on a result of the comparison.

14. An operation method of a robot, comprising:
acquiring, using a first camera sensor arranged at a first capturing angle, a first image corresponding to a first area within a driving space of the robot;
identifying, based on the first image, a second image, corresponding to a second capturing angle, in which a second area within the driving space is reflected by a mirror located at a first arrangement angle at a first location of the robot;
identifying a third image of the second area captured at the first capturing angle based on the acquired first image; and
identifying an object of a liquid type within the second area based on the second image corresponding to the second capturing angle and the third image corresponding to the first capturing angle.

15. The operation method as claimed in claim 14, wherein the first capturing angle is an angle at which the first camera sensor is tilted with respect to a line perpendicular to a ground, and
wherein the second capturing angle is a capturing angle corresponding to a reflected image that is reflected by the mirror arranged at the first arrangement angle.

16. The operation method as claimed in claim 14, wherein the first area includes the second area, and
wherein the operation method further comprises:
calibrating the second image;
identifying the third image corresponding to an area matching the second image among the first image corresponding to the first area; and
providing the calibrated second image and the identified third image to a first trained neural network model to identify whether the object of the liquid type exists within the second area.

17. The operation method as claimed in claim 16, wherein the instructions, wherein the operation method further comprises:
providing the calibrated second image and the identified third image to a trained second neural network model to identify whether the object of the liquid type exists within the second area;
providing the calibrated second image and the identified third image to a trained third neural network model to identify location information of the object of the liquid type based on identifying that the object of the liquid type exists within the second area; and
performing at least one of avoidance driving for the object of the liquid type or a removal operation for the object of the liquid type based on the identified location information.

18. The operation method as claimed in claim 16, wherein the instructions, wherein the operation method further comprises:
providing the calibrated second image and the identified third image to a trained fourth neural network model to identify location information of another object of a preset type existing within the second area; and
performing avoidance driving for the another object of the preset type based on the identified location information.

19. The operation method as claimed in claim 14, wherein the first location is included in an area corresponding to a field of view of the first camera sensor, and is a relatively higher location than the first camera sensor.

20. A non-transitory computer-readable storage medium storing instructions, wherein the instructions, when executed by at least one processor of a robot, cause the robot to:
acquire, using a first camera sensor arranged at a first capturing angle, a first image corresponding to a first area within a driving space of the robot;
identify, based on the first image, a second image, corresponding to a second capturing angle, in which a second area within the driving space is reflected by a mirror located at a first arrangement angle at a first location of the robot;
identify a third image of the second area captured at the first capturing angle based on the acquired first image; and
identify an object of a liquid type within the second area based on the second image corresponding to the second capturing angle and the third image corresponding to the first capturing angle.
